(19) United States
(12) Patent Application Publication
(10) Pub. No.: US 2025/0130125 A1
(43) Pub. Date: Apr. 24, 2025

(54) Optical Sensor System

(71) Applicant: United States of America as Represented by the Administrator of NASA, Washington DC, DC (US)

(72) Inventors: Allen Parker, Lancaster, CA (US); Patrick Chan, Santa Clarita, CA (US); Jonathan Lopez, Lancaster, CA (US); Frank Pena, Altadena, CA (US); Craig Stephens, Palmdale, CA (US)

(21) Appl. No.: 18/923,456

(22) Filed: Oct. 22, 2024

Related U.S. Application Data
(60) Provisional application No. 63/545,266, filed on Oct. 23, 2023.

(51) Int. Cl. G01L 1/24; G01K 11/3206

(52) U.S. Cl. CPC G01L 1/246; G01K 11/3206

(57) ABSTRACT

An optical sensor system may include optical fibers having at least one corresponding optical sensing element configured to reflect light; a laser configured to output light of a discrete wavelength and to change the discrete wavelength through a sequence; an optical network connecting the laser to the optical fibers, and configured to split the output light so that a split portion of the output light is transmitted through an optical fiber of the optical fibers to the at least one corresponding optical sensing element which may reflect at least a portion of the split portion; an optical sensor configured to obtain information about of the reflected light and to output data corresponding to the information about the reflected light; and a processor configured to: obtain, from the optical sensor, the data corresponding to the information about the reflected light in correspondence with discrete wavelengths of the sequence.

### CROSS-REFERENCE TO RELATED PATENT APPLICATION(S)

This patent application claims the benefit of and priority to U.S. Provisional Application No. 63/545,266, filed on Oct. 23, 2023, the contents of which are hereby incorporated by reference in their entirety.

### STATEMENT REGARDING FEDERALLY SPONSORED RESEARCH OR DEVELOPMENT

The invention described herein was made by employees of the United States Government and may be manufactured and used by or for the Government of the United States of America for governmental purposes without the payment of any royalties thereon or therefore.

### BACKGROUND OF THE INVENTION

Non-Destructive Evaluation (NDE) of an aerospace structure may be used to assess the structure's integrity. For example, NDE techniques, such as in-situ Structural Health Monitoring (SHM), may be used to assess a structure's potential for failure. Such assessments may have implications for the safety and reliability of the structure and may be used to make decisions as to whether the structure is suitable for continued service. Using such techniques may reduce down-time associated with periodic inspection (e.g., which may include disassembling structural components).

One method of NDE includes installation of mechanical strain gauges and temperature sensors in the aerospace structure. These gauges and sensors may be tedious and labor intensive to install, heavy, and may include complicated wiring to deploy. Even when such gauges and sensor are consolidated into harnesses, they may be bulky and cumbersome to route through aerospace parts which may be light and compact so as to improve fuel economy of the vehicles that incorporate the structures.

### BRIEF SUMMARY OF THE INVENTION

In accordance with the present disclosure, an optical sensor system may include: a plurality of optical fibers, each optical fiber of the plurality of optical fibers having at least one corresponding optical sensing element configured to reflect light; a laser configured to output light of a discrete wavelength and to change the discrete wavelength of the output light through a sequence of discrete wavelengths; an optical network connecting the laser to the plurality of optical fibers, and configured to split the output light of the discrete wavelength so that a split portion of the output light of the discrete wavelength is transmitted through an optical fiber of the plurality of optical fibers to the at least one corresponding optical sensing element and at least a portion of the split portion is reflected by the at least one corresponding optical sensing element; an optical sensor configured to obtain information about the reflected light through optical fibers of the plurality of optical fibers and to output data corresponding to the information about the reflected light; and a processor configured to: obtain, from the optical sensor, the data corresponding to the information about the reflected light in correspondence with discrete wavelengths of the sequence of discrete wavelengths.

In an embodiment of the disclosure, the at least one corresponding optical sensing element may include an extrinsic Fabry-Perot interferometer and the information about the reflected light may include an amplitude of the reflected light, or the at least one corresponding optical sensing element may include at least one fiber Braggs grating and the information about the reflected light may include a wavelength of the reflected light, and the processor may be further configured to: based on at least one of a wavelength difference between the output light of the discrete wavelength and the wavelength of the reflected light and a phase change between an amplitude of the output light of the discrete wavelength and the amplitude of the reflected light, determine a strain for an optical fiber of the plurality of optical fibers including the extrinsic Fabry-Perot interferometer or the at least one fiber Braggs grating, or determine a temperature of an optical fiber of the plurality of optical fibers including the at least one fiber Braggs grating.

In an embodiment of the disclosure, the at least one corresponding optical sensing element may include an extrinsic Fabry-Perot interferometer, the information about the reflected light may include an amplitude of the reflected light, and the processor may be further configured to: based on a phase change between an amplitude of the output light of the discrete wavelength and the amplitude of the reflected light, determine a strain for an optical fiber of the plurality of optical fibers that includes the extrinsic Fabry-Perot interferometer.

In an embodiment of the disclosure, the at least one corresponding optical sensing element may include at least one fiber Braggs grating, the information about the reflected light may include a wavelength of the reflected light, and the processor may be further configured to: based on a wavelength difference between the output light of the discrete wavelength and the wavelength of the reflected light, determine a strain for an optical fiber of the plurality of optical fibers that includes the at least one fiber Braggs grating.

In an embodiment of the disclosure, the at least one corresponding optical sensing element may include at least one fiber Braggs grating, the information about the reflected light may include a wavelength of the reflected light, and the processor may be further configured to: based on a wavelength difference between the output light of the discrete wavelength and the wavelength of the reflected light, determine a temperature of an optical fiber of the plurality of optical fibers that includes the at least one fiber Braggs grating.

In an embodiment of the disclosure, the sequence of discrete wavelengths may include wavelengths between about 1400 nanometers to about 1600 nanometers.

In an embodiment of the disclosure, the processor may be further configured to change, with the laser, the discrete wavelength of the output light through the sequence of discrete wavelengths within about 50 milliseconds.

In an embodiment of the disclosure, the optical sensor may further include an optical to electrical amplifier configured to convert the wavelength of light reflected by the at least one corresponding optical sensing element into an electrical signal.

In an embodiment of the disclosure, the laser may be configured to output a coordination signal to the optical sensor when the laser changes the discrete wavelength of the output light at each discrete wavelength of the sequence of discrete wavelengths, and the coordination signal includes: a start command to start sensing with the optical sensor, and a clock to determine a sensing speed of the optical sensor.

In an embodiment of the disclosure, the processor may be further configured to: obtain, from the optical sensor, the data corresponding to the information about the reflected light through each optical fibers of the plurality of optical fibers in correspondence with each discrete wavelength of the sequence of discrete wavelengths.

In an embodiment of the disclosure, the optical sensor system may further include a housing in which the laser, the optical network, the optical sensor and the processor are housed and through which the plurality of optical fibers extend.

In accordance with the present disclosure, an aerospace vehicle may include: a structural component; and the aforementioned optical sensor system, wherein at least one optical fiber of the plurality of optical fibers may be configured to sense a strain or a temperature of the structural component when the aerospace vehicle is in service.

In an embodiment of the disclosure, the optical sensor system may be configured to transmit data collected by the processor to an external device.

In accordance with the present disclosure, a method of controlling an optical sensor system including a plurality of optical fibers, each optical fiber of the plurality of optical fibers having at least one corresponding optical sensing element configured to reflect light, a laser configured to output light of a discrete wavelength and to change the discrete wavelength of the output light through a sequence of discrete wavelengths, an optical network connecting the laser to the plurality of optical fibers, and configured to split the output light of the discrete wavelength so that a split portion of the output light of the discrete wavelength is transmitted through each optical fiber of the plurality of optical fibers to the at least one corresponding optical sensing element and at least a portion of the split portion is reflected by the at least one corresponding optical sensing element, an optical sensor configured to obtain information about the reflected light through each optical fiber of the plurality of optical fibers and to output data corresponding to the information about the reflected light, and a processor, the method may include: changing a wavelength of light output by the laser through the sequence of discrete wavelengths; and obtaining, from the optical sensor, the data corresponding to the information about the reflected light in correspondence with discrete wavelengths of the sequence of discrete wavelengths.

In an embodiment of the disclosure, the at least one corresponding optical sensing element may include an extrinsic Fabry-Perot interferometer and the information about the reflected light may include an amplitude of the reflected light, or the at least one corresponding optical sensing element may include at least one fiber Braggs grating and the information about the reflected light may include a wavelength of the reflected light, and the method may further include: based on at least one of a wavelength difference between the output light of the discrete wavelength and the wavelength of the reflected light and a phase change between an amplitude of the output light of the discrete wavelength and the amplitude of the reflected light, determining a strain for an optical fiber of the plurality of optical fibers including the extrinsic Fabry-Perot interferometer or the at least one fiber Braggs grating, or determining a temperature of an optical fiber of the plurality of optical fibers including the at least one fiber Braggs grating.

In an embodiment of the disclosure, the at least one corresponding optical sensing element may include an extrinsic Fabry-Perot interferometer, the information about the reflected light may include an amplitude of the reflected light, and the method may further include: based on a phase change between an amplitude of the output light of the discrete wavelength and the amplitude of the reflected light, determining a strain for an optical fiber of the plurality of optical fibers that includes the extrinsic Fabry-Perot interferometer.

In an embodiment of the disclosure, the at least one corresponding optical sensing element may include at least one fiber Braggs grating, the information about the reflected light may include a wavelength of the reflected light, and the method may further include: based on a wavelength difference between the output light of the discrete wavelength and the wavelength of the reflected light, determining a strain for an optical fiber of the plurality of optical fibers that includes the at least one fiber Braggs grating.

In an embodiment of the disclosure, the at least one corresponding optical sensing element may include at least one fiber Braggs grating, the information about the reflected light may include a wavelength of the reflected light, and the method may further include: based on a wavelength difference between the output light of the discrete wavelength and the wavelength of the reflected light, determining a temperature of an optical fiber of the plurality of optical fibers that includes the at least one fiber Braggs grating.

In an embodiment of the disclosure, the sensing may include sensing the information about the reflected light through each optical fiber of the plurality of optical fibers in correspondence with each discrete wavelengths of the sequence of discrete wavelengths.

In an embodiment of the disclosure, the method may further include: outputting, with the laser, a coordination signal to the optical sensor when the laser changes the discrete wavelength of the output light at discrete wavelengths of the sequence of discrete wavelengths.

These and other features, advantages, and objects of the present invention will be further understood and appreciated by those skilled in the art by reference to the following specification, claims, and appended drawings.

### BRIEF DESCRIPTION OF THE SEVERAL VIEWS OF THE DRAWINGS

FIG. 1 is a schematic illustration of an optical sensor system; and

FIG. 2 is a schematic illustration of a method of the optical sensor system of FIG. 1.

### DETAILED DESCRIPTION OF THE INVENTION

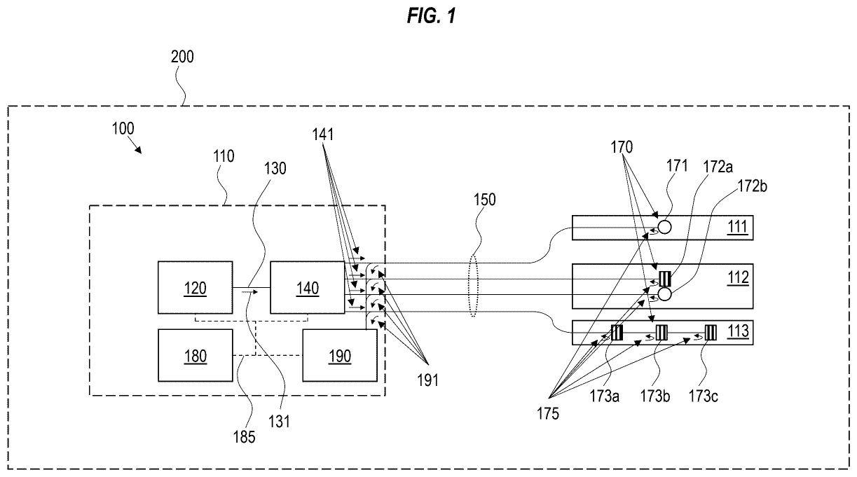

For purposes of description herein, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations and step sequences, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

In comparison to mechanical SHM systems, fiber optic-based sensing systems may be light, small, and easily maneuvered through aerospace structures during installation. Additionally, fiber optic-based sensing systems may be installed into structural sub-systems during manufacturing which may result in faster and less labor-intensive installation of SHM apparatus. Accordingly, fiber optic-based sensing systems may be an alternative to heavy, bulky, and complicated mechanical SHM systems. Additionally, fiber optic-based sensing systems may offer improved reliability in comparison to mechanical SHM systems.

As shown in FIG. 1, an optical sensor system 100 may include a laser 120, a optical network 140, a plurality of optical fibers 150, at least one corresponding optical sensing element 170 (e.g., corresponding to the plurality of optical fibers 150), an optical sensor 190, and a processor 180.

The plurality of optical fibers 150 may include one or more optical fibers, such as from about 1 optical fiber to about 128 optical fibers, or from about 1 optical fiber to about 64 optical fibers, or from about 1 optical fiber to about 32 optical fibers, or from about 1 optical fiber to about 24 optical fibers, or from about 1 optical fiber to about 16 optical fibers. In some implementations the plurality of optical fibers 150 may include 4 optical fibers, 8 optical fibers, 12 optical fibers, 16 optical fibers, 24 optical fibers, or 32 optical fibers.

Optical fibers of the plurality of optical fibers 150 may include at least one corresponding optical sensing element 170 which may be configured to reflect light. For example, the at least one corresponding optical sensing element 170 may include one or more fiber Braggs grating (FBG) (e.g., shown as FBG 172a, and 173a-c in FIG. 1) or an extrinsic Fabry-Perot interferometer (EFPI) (e.g., shown as EFPI 171 and 172b in FIG. 1) which will be described in detail in the following.

The optical sensor system 100 may include a laser 120 configured to output light of a discrete wavelength (e.g., shown with arrow 131 in FIG. 1). For example, the laser 120 may output a single beam 130 of light of the discrete wavelength. The discrete wavelength may be any wavelength. For example, the discrete wavelength of the output light may be from about 1300 nanometers (nm) to about 1700 nm, or from about 1350 nm to about 1650 nm, or from about 1400 nm to about 1600 nm, or from about 1450 nm to about 1550 nm, or from about 1500 nm to about 1600 nm, or from about 1460 nm to about 1520 nm, or from about 1520 nm to about 1580 nm, or from about 1580 nm to about 1640 nm, or from about 1480 nm to about 1520 nm, or from about 1520 nm to about 1560 nm, or from about 1560 nm to about 1600 nm, or from about 1500 nm to about 1540 nm, or from about 1540 nm to about 1580 nm, or from about 1580 nm to about 1620 nm.

The laser 120 may be configured to change the discrete wavelength of light that is output (e.g., based on a command received by the laser 120). The laser 120 may be configured to change the discrete wavelength of light that is output through a plurality of wavelengths of a wavelength band (e.g., through a sequence of discrete wavelengths of the wavelength band). Such changing of the discrete wavelength of light that is output by the laser 120 may be referred to as a “sweep”. In other words, the laser 120 may sweep through a specified wavelength band by changing the discrete wavelength of light output by the laser 120. The wavelength band may be any wavelength band. For example, the wavelength band may be about 10 nm, about 20, nm, about 30 nm, about 40 nm, about 50 nm, about 60 nm, about 70 nm, about 80 nm, or more. In an implementation, the wavelength band may be about 40 nm. In an implementation, the laser 120 may be configured to output light in a sequence of discrete wavelengths including wavelengths between about 1500 nanometers to about 1600 nanometers, or between about 1510 nm to about 1580 nm, or between about 1530 nm to about 1570 nm. In an implementation, the laser 120 may be a Distributed Bragg Reflector (DBR) laser where the laser cavity waveguide is bounded on one end by a Bragg mirror and bounded on the other end by an anti-reflective mirror. The laser 120 may include a gain cavity. The laser 120 may be electronically tunable by changing the gain cavity's injection current. The laser 120 may have no moving parts. In other words, the laser 120 may be free of moving parts. The laser 120 may include a dedicated phase control section and a laser gain chip. Control of the laser 120 may be provided by adjusting the injection current from both mirrors, the phase control section and the laser gain chip.

The laser 120 may have a configurable tuning resolution and sweep speed. Regarding the configurable resolution, the laser may be configured to change between discrete wavelengths of light that is output by the laser 120 (e.g., in steps). The steps may be any magnitude of change in wavelength (e.g., step size). For example, the laser 120 may be configured to step the discrete wavelength of output light in steps having a step size of greater than or equal to about 1 picometer (pm), such as greater than or equal to about 2 pm, or greater than or equal to about 4 pm, or greater than or equal to about 5 pm, or greater than or equal to about 6 pm, or greater than or equal to about 8 pm, or greater than or equal to about 10 pm, or greater than or equal to about 20 pm, or greater than or equal to about 30 pm, or greater than or equal to about 40 pm, or greater than or equal to about 50 pm, or greater than or equal to about 60 pm, or greater than or equal to about 70 pm, or greater than or equal to about 80 pm, or greater than or equal to about 90 pm, or greater than or equal to about 100 pm, or the like. In an implementation the wavelength step size is about 40 pm. In an implementation, the wavelength band is about 40 nm and the wavelength step size is about 40 pm, so that the laser 120 is configured to step through about 10,000 steps in the wavelength band in order to complete all the steps in the wavelength band. In an implementation, the wavelength step size may be less than the size of the wavelength band and the wavelength band may be divided by an integer number of steps.

Regarding the configurable sweep speed of the laser 120, the laser 120 may hold the output at a discrete wavelength for a configurable duration (e.g., which may also be referred to herein as the “dwell time” of the laser 120). In this way, the speed that it takes the laser 120 to change between discrete wavelength outputs may be adjustable. For example, the duration of each step may be greater than or equal to about 1 microsecond (μs), such as about 2 μs, or about 3 μs, or about 4 μs, or about 5 μs, or about 6 μs, or about 7 μs, or about 8 μs, or about 9 μs, or about 10 μs, or about 20 μs, or about 50 μs, or about 100 μs, or about 500 μs or, about 1 millisecond (ms), or about 2 ms or about 3 ms or about 4 ms, or so forth. Accordingly, the time it takes the laser 120 to complete all the steps in a complete sweep of a wavelength band may be configurable based on the step size and the duration of each step. In an implementation, the wavelength band may be about 40 nm, the wavelength step size may be 4 pm, and the duration of each step may be about 2 μs so that a time to complete a complete sweep of the wavelength band (e.g., the outputting of 10,000 discrete wavelength for 2 μs at each wavelength) may be about 20 ms (e.g., meaning the laser 120 may sweep the complete 40 nm wavelength band at about 50 Hz). The speed to complete a sweep of a wavelength band may be increased to about 500 Hz (e.g., by skipping some of the discrete wavelength steps such as by increasing the step size, (e.g., from 4 pm to 40 pm)) and/or sweeping a smaller wavelength band (e.g., reducing the wavelength band, such as from 40 nm to 20 nm) while maintaining the same duration of each step (e.g., 2 μs). In an implementation, the optical sensor system 100 may be configured to change, with the laser 120, the discrete wavelength of the output light through a wavelength band of discrete wavelengths (e.g., a 40 nm band) within about 50 ms, or within about 40 ms, or within about 30 ms, or within about 20 ms.

As can be understood from the foregoing, a tradeoff may be made as to the resolution of the sweep (e.g., number of steps within a wavelength band), the size of the sweep (e.g., the size of the wavelength band), and the speed of the sweep (e.g., the hold time that the laser 120 holds a discrete wavelength during the sweep).

The laser 120 may change the discrete wavelength of output light in any manner. For example, the laser 120 may increment the wavelength in steps of a selected wavelength step size from the lowest wavelength of the wavelength band to the highest wavelength of the wavelength band. Alternatively, the laser 120 may decrement the wavelength in steps of a selected wavelength step size from the highest wavelength of the wavelength band to the lowest wavelength of the wavelength band. Other wavelength changing approaches may be utilized. For example, the laser 120 may increment or decrement the wavelength in steps of a selected wavelength step size from the any first wavelength of the wavelength band to any second wavelength of the wavelength band. In some cases, the laser 120 may be configured to skip steps, to alternate incrementing and decrementing steps, to increment by more than one step followed by decrementing by one step, to decrement by more than one step followed by incrementing by one step, or any other sequence. In some cases, the laser 120 may be configured to skip end points of the wavelength band. Selection of the step size, step order, sweep speed, and wavelength band may be based on the application of the optical sensor system 100.

The optical sensor system 100 may include an optical network 140 connecting the laser 120 to the plurality of optical fibers 150. For example, the optical network may optically connect the laser 120 to the plurality of optical fibers 150 so that there is optical communication between output light of the laser 120 and the plurality of optical fibers 150. The optical network 140 may be configured to split the output light of the discrete wavelength (e.g., single beam 130) so that a split portion of the output light of the discrete wavelength is transmitted through an optical fiber of the plurality of optical fibers 150 (e.g., through each optical fiber of the plurality of optical fibers, as shown with arrows 141 in FIG. 1). The split portions of output light may be transmitted through the optical fiber of the plurality of optical fibers 150 to at least one corresponding optical sensing element 170 and at least a portion of the split portion may be reflected by the at least one corresponding optical sensing element 170 (as show with return arrows 175 in FIG. 1). For example, the optical network 140 may include an optical splitter to split the output light of the discrete wavelength into a plurality of channels corresponding to the plurality of optical fibers 150. The optical splitter may proportionally split the output light so that each channel of the plurality of output channels receives an equal portion of the output light (e.g., a four-way optical splitter may split the output light into four portions which each receive 25% of the output light, an eight-way optical splitter may split the output light into eight portion which each receive 12.5% of the output light, and so forth).

The optical sensor system 100 may include an optical sensor 190 configured to obtain information about the reflected light through optical fibers of the plurality of optical fibers 150 (e.g., each optical fiber of the plurality of optical fibers 150, as show with arrows 191 in FIG. 1). The optical sensor system 100 may include an optical sensor 190 configured to sense information about the reflected light through optical fibers of the plurality of optical fibers 150. For example, the optical sensor 190 may include an analog-to-digital converter (e.g., a field programmable gate array (FPGA)-based analog-to-digital converter), which may be configured to convert information about photons received by the optical sensor 190 during a sampling time to a corresponding electric signal (e.g., current, voltage, or the like). The corresponding electric signal may be interpreted (e.g., by the optical sensor 190, the processor 180, and/or a data acquisition device) to determine information about the reflected light. The information about the reflected light may include a wavelength of the reflected light, an amplitude of the reflected light, a frequency of the reflected light, an intensity of the reflected light, a phase change of the reflected light relative to the light output by the laser 120, and the like. The processor 180 and/or the optical sensor 190 may include a data acquisition device which may be configured to monitor and record data associated with the information about the reflected light obtained by the optical sensor 190. Alternatively, or in addition, the processor 180 and/or the optical sensor 190 may be configured perform a data acquisition function (e.g., to monitor and record data associated with the reflected light sensed by the optical sensor 190).

The optical sensor 190 may include multiplexing (e.g., time-division multiplexing) so that the optical sensor 190 may be able to sample optical fibers (e.g., each optical fiber) of the plurality of optical fibers 150 sequentially within a sampling period. For example, in an implementation where the plurality of optical fibers 150 includes n optical fibers, the optical sensor 190 may be configured to sequentially sample the reflected light from the first through n^{th} optical fiber during a sampling period which is equally divided into n parts. During the sequential sampling, the light output from the laser 120 may be held fixed at a discrete wavelength of the wavelength band. In this way, the optical sensor 190 may sense the reflected light from up to all of the optical fibers of the plurality of optical fibers 150 while the laser 120 maintains outputting light of the discrete wavelength. The optical sensor 190 may be configured to sample the reflected light from up to all of the optical fibers of the plurality of optical fibers 150 while the laser 120 is fixed at each step of a wavelength band. In this way, the optical sensor 190 may sample the reflected light from n channels within the step duration of the laser 120. Such a multiplexed sampling technique may be referred to as “sweeping”.

Accordingly, the optical sensor 190 may be configured to sample reflected light from up to all of the optical fibers of the plurality of optical fibers 150 during the dwell time of the laser 120. In this way, in an implementation where the wavelength band is about 40 nm, the wavelength step size is 4 pm, and the duration of each step is about 2 μs, the optical sensor may sense the reflected light for up to 10,000 data points for each optical fiber up to all the optical fibers of the plurality of optical fibers 150 for each complete sweep of the laser 120 through the entire wavelength band. Therefore, when the plurality of optical fibers includes eight optical fibers, the optical sensor 190 may sense about 80,000 data points within about 20 ms (the time for one complete sweep when sweeping at 50 Hz). Moreover, in this implementation, the optical sensor 190 may sense up to about 4,000,000 data points in one second. Similarly, in an implementation where the plurality of optical fibers 150 includes four optical fibers, the optical sensor 190 may sense up to about 2,000,000 data points in one second. As can be understood from the foregoing, so long as the sensing speed of the optical sensor 190 is less than or equal to the dwell time of the laser 120, the number of data points the optical sensor 190 may sense may be a function of the number of optical fibers of the plurality of optical fibers 150.

The optical sensor 190 may include one or more photodiodes configured to receive reflected light from the at least one corresponding optical sensing element 170 and to generate a corresponding electrical signal. When the optical sensor 190 includes two or more photodiodes, the optical sensor 190 may include an electronically controlled switch configured to switch an analog-to-digital converter between reading the output of a photodiode, or each photodiode, of the two or more photodiodes (e.g., which may be done during the dwell time of the laser 120 so that a reading (e.g., a voltage) from each photodiodes of the two or more photodiodes may be processed by the analog-to-digital converter before the laser 120 changes the wavelength of output light).

The optical sensor 190 may include an optical to electrical amplifier which may be configured to convert the wavelength of light input into the optical sensor 190 (e.g., the light reflected by the at least one corresponding optical sensing element 170) into an electrical signal.

The optical sensor system 100 may include a processor 180. The processor may be configured to control, at least portions of, the optical sensor system 100. The processor 180 may be configured to change, with the laser 120, the discrete wavelength of the output light through a sequence of discrete wavelengths (e.g., through a wavelength band). The processor 180 may be configured to obtain, from the optical sensor 190, information indicative of the information about the reflected light through optical fibers (e.g., one or more optical fibers, or each optical fiber) of the plurality of optical fibers 150 in correspondence with discrete wavelengths of the sequence of discrete wavelengths (e.g., one of more discrete wavelengths, or each discrete wavelength). For example, the processor 180 may be configured to coordinate actions of the laser 120 and the optical sensor 190 so that at each discrete wavelength of a wavelength band, the optical sensor 190 obtains information indicative of the information about the reflected light from up to all of the optical fibers of the plurality of optical fibers 150.

The processor 180 may include a computing apparatus, such as (in a non-limiting example) any computer or computer processor, that includes processing hardware and/or software implemented on the processing hardware to transmit and receive (communicate (network) with other computing apparatuses), store and retrieve from computer readable storage media, process and/or output data. According to an aspect of an implementation, the described features, functions, operations, processes, methods, steps, and/or benefits may be implemented by and/or use processing hardware and/or software executed by processing hardware. For example, a processor 180, as illustrated in FIG. 1 may include a central processing unit (CPU) or a computing processing system (e.g., one or more processing devices (e.g., chipset(s), including memory, etc.) that may process or execute instructions, namely software, program(s), and/or application(s), which may be stored in a memory and/or a computer readable storage media (e.g., read-only memory (ROM), flash memory, hard disk, solid state memory, and the like), transmission communication interface (e.g., network interface, wire/wireless data network interface), input device (e.g., mouse, keyboard, multi-touch display, audio microphone, sensor, and the like), and/or an output device, for example, a display device (e.g., multi-touch display, audio speaker, visual display, and the like), a printing device, and which may be coupled (directly or indirectly) to each other, for example, may be in communication among each other through one or more data communication buses.

In an implementation, the processor 180 may be configured to control at least one of the laser 120, the optical network 140, and the optical sensor 190. The processor 180 may be configured to communicate via a communication network 185 (e.g., shown in dashed lines in FIG. 1) to at least one of the laser 120, the optical network 140, the optical sensor 190, and an external device (e.g., client computer). The communication network 185 may be wireless or wired. The at least one of the laser 120, the optical network 140, the processor 180, the optical sensor 190, and the external device may include a communication interface to receive and/or send communication signals through the communication network 185. The communication network 185 may be configured to operate with any suitable communications protocol, such as including user datagram protocol (UDP), to coordinate communications over the network.

In addition, an apparatus may include one or more apparatuses in computer network communication with each other or other apparatuses and the implementations relate to control and/or communication of aspects of the disclosed features, functions, operations, processes, methods, steps, and/or benefits, for example, data or information involving local area network (LAN) and/or Intranet based computing, cloud computing in case of Internet based computing, Internet of Things (IoT) (network of physical objects—computer readable storage media (e.g., databases, knowledge bases), devices (e.g., appliances, cameras, mobile phones), vehicles, buildings, and other items, embedded with electronics, software, sensors that generate, collect, search (query), process, and/or analyze data, with network connectivity to exchange the data), online websites. In addition, a computer processor may refer to one or more computer processors in one or more apparatuses or any combinations of one or more computer processors and/or apparatuses. An aspect of an implementation relates to causing and/or configuring one or more apparatuses and/or computer processors to execute the described operations. The results produced may be output to an output device, for example, displayed on the display or by way of audio/sound. An apparatus or device refers to a physical machine that performs operations by way of electronics, mechanical processes, for example, electromechanical devices, sensors, a computer (physical computing hardware or machinery) that implement or execute instructions, for example, execute instructions by way of software, which is code executed by computing hardware including a programmable chip (e.g., chipset, computer processor, electronic component), and/or implement instructions by way of computing hardware (e.g., in circuitry, electronic components in integrated circuits, and the like)—collectively referred to as hardware processor(s), to achieve the functions or operations being described. The functions of embodiments described may be implemented in a type of apparatus that may execute instructions or code.

More particularly, programming or configuring or causing an apparatus or device, for example, a computer, to execute the described functions of implementation of the disclosure creates a new machine where in case of a computer a general-purpose computer in effect becomes a special purpose computer once it is programmed or configured or caused to perform particular functions of the implementations of the disclosure pursuant to instructions from program software. According to an aspect of an embodiment, configuring an apparatus, device, computer processor, refers to such apparatus, device or computer processor programmed or controlled by software to execute the described functions.

A program/software implementing the embodiments may be recorded on a computer-readable storage media, e.g., a non-transitory or persistent computer-readable storage medium. Examples of the non-transitory computer-readable media include a magnetic recording apparatus, an optical disk, a magneto-optical disk, and/or volatile and/or non-volatile semiconductor memory (for example, random access memory (RAM), ROM, etc.). Examples of the magnetic recording apparatus include a hard disk device (HDD), a flexible disk (FD), and a magnetic tape (MT). Examples of the optical disk include a DVD (Digital Versatile Disc), DVD-Read-only memory (DVD-ROM), DVD-Random Access Memory (DVD-RAM), BD (Blue-ray Disk), a Compact Disc (CD)-Read Only Memory (CD-ROM), a CD-Recordable (CD-R) and/or CD-Rewritable (CD-RW). The program/software implementing the embodiments may be transmitted over a transmission communication path, e.g., a wire and/or a wireless network implemented via hardware. An example of communication media via which the program/software may be sent includes, for example, a carrier-wave signal.

The at least one corresponding optical sensing element 170 may include one or more FBG (e.g., shown as FBG 172a, and 173a-c in FIG. 1). The FBG may include an optical element having a grating structure (e.g., a periodic grating structure) configured to reflect a particular wavelength of incident light based on a spacing between the periodic grating structure and transmit all other incident light. For example, the Braggs wavelength (λ_{B}) may be related to the spacing (Λ) of the periodic grating structure based on Equation 1:

$${λ}_{B} = 2 {n}_{e} Λ \qquad Equation 1$$

Where λ_{B}=initial Bragg wavelength of the FBG, nₑ=effective reflective index and Λ the spacing between elements of the grating structure.

The grating structure may be written into an optical fiber (e.g., into a fiber core of the optical fiber) in specific locations so as to form a portion of the optical fiber that reflects light incident on the optical grating. For example, a fiber core may be doped with germanium (Ge), masked with a periodic pattern, and bombarded with an ultraviolet (UV) light which may be uniformly absorbed to the Ge-doped fiber core thereby permanently writing the periodic pattern to the fiber core. The resulting FBG may act as a mirror thereby reflecting light of a particular wavelength that is incident thereon. The fiber portion surrounding the fiber core may aid in transmitting the reflected light (e.g., through total internal reflection) back toward the direction of the incident light. The wavelength of light reflected by the FBG may change based on changes in the spacing of the periodic structure. In this way, as the optical fiber elongates or contracts (e.g., in an axial direction of the optical fiber) the spacing of the periodic grating changes and correspondingly changes the wavelength of light reflected by the grating.

By measuring a change in the wavelength of light between the light transmitted by the laser 120 to the FBG and the light reflected by the FBG, a determination of the elongation or contraction may be made. For example, Equation 2 may be used to discern the strain (ε) or the change in temperature (ΔT) due to the change in the Braggs wavelength based on the initial Bragg wavelength of the FBG (e.g., known from the periodic spacing of the FBG when manufactured).

$$\frac{Δ {λ}_{B}}{{λ}_{B}} = ( 1 - {p}_{e} ) ε + ( {α}_{Λ} + {α}_{n} ) Δ T \qquad Equation 2$$

Where, Δλ_{B}=change in Bragg wavelength due to elongation or contraction, λ_{B}=initial Bragg wavelength of the FBG, pₑ=strain-optics coefficient, α_{Λ}=coefficient of thermal expansion (CTE), and αₙ=thermo-optic coefficient, and ΔT=temperature difference. The at least one corresponding optical sensing element 170 may include an EFPI (e.g., shown as EFPI 171 and 172b in FIG. 1). A EFPI may include two separate optical fibers arranged coaxially so that the two separate ends are spaced apart by a set gap length (L_{c}). The two separate optical fibers may be joined via a hollow-core extrinsic tubing which surrounds the two separate fiber ends. The optical fibers may have a fiber outside diameter of about 125 μm and a 6 μm core. The hollow-core extrinsic tubing may include a silica micro-capillary tubing and may have an outer diameter of about 285 μm and an inner diameter of about 130 μm. The two separate fibers may be coated with a transition meta (e.g., Group 3-12 of the periodic table, such as gold coated) and may be attached to a surface with attachments (e.g., made of a ceramic material) which may be spaced about by an initial gap length (L_{G}), where L_{G}>L_{c}. Light incident to the EFPI may reflect from the first fiber end and from the second fiber end and differences in the characteristics of the reflected light may be used to discern a change the gap length L_{c} thereby allowing for determination of elongation or contraction and resultant strain (ε).

The difference in the path length that the incident light travels between the two end surfaces may correspond to a difference in time that the reflected light reaches the optical sensor 190. For example, when the set gap length Le has not changed then the difference in time that it takes the reflected light to reach the optical sensor 190 from the first end and from the second end may not change (e.g., may be equal to the initial reflection time) and it may be concluded that no strain has occurred at the EFPI. However, when the set gap length L_{c} changes the difference in the time it takes for the reflected light to reach the optical sensor 190 will change corresponding to the elongation or contraction of the gap length L_{c} and this time difference may be used to determine the amount of elongation or contraction.

By measuring the phase change of light reflected from the two separated fiber ends the gap length (L_{c}) may be determined. For example, the gap length may be a function of the phase change (ΔØ) in accordance with the Equation 3:

$${I}_{r} = {A}_{1}^{2} + {A}_{2}^{2} + 2 {A}_{1} {A}_{2} cos Δ ∅ \qquad Equation 3$$

Where, Iᵣ=Reflected signal intensity, A₁=Initial reflection amplitude before the air gap, A₂=Reflection amplitude after the air gap, and ΔØ=the phase change due to the gap length changes.

Furthermore, the strain (ε) may be determined by dividing the change in gap length L_{c} by the initial gap length L_{G}. In this case, the sensitivity of the EFPI may be equal to L_{G} (e.g., a change in gap length Le of greater than the initial gap length L_{G} may not result in a reliable measure of strain). Additionally, the apparent strain (ξapp) may be determined according to Equation 4:

$$ξ app = ( {α}_{s u b} - {α}_{fiber} ) \times Δ T \qquad Equation 4$$

Where, ξapp=apparent strain, αsub=CTE of the bonded substrate, αfiber=CTE of the fiber, and ΔT=the temperature difference as measured by another dedicated temperature sensor.

When an optical fiber includes an EFPI, additional EFPI's or FGB's may not be included in the same fiber. This is due to nature of the EFPI, where a physical gap between the two separate fiber ends is present. Such a physical gap may not allow light to be transmitted through the optical fiber past the location of the EFPI element.

The processor 180 may be configured to record into a data storage device data (e.g., frequency, wavelength, period, phase, phase change, and the like) associated with the light output from the laser 120 and the reflected light sampled by the optical sensor 190 from the plurality of optical fibers 150 at each step of the wavelength band. In this way, the processor 180 or a data processing module (e.g., a computer able to retrieve data from the data storage device) may be able to determine at least one of a wavelength difference between the output light of the discrete wavelength (e.g., output by the laser 120) and the wavelength of the reflected light (e.g., the light received by the optical sensor 190), and a phase change of the reflected light from the two separate ends of the EFPI. The processor 180 or the data processing module may be further configured to determine strain (ε), apparent strain (ξapp), temperature (T), temperature difference ΔT, and the like (e.g., based on the foregoing equations).

Based on the determined wavelength difference, the processor 180 and/or the data processing module may be configured to determine a strain for an optical fiber of the plurality of optical fibers 150 including the at least one FBG, and/or determine a temperature of an optical fiber of the plurality of optical fibers 150 including the at least one FBG.

Based on the determined phase change, the processor 180 and/or the data processing module may be configured to determine a strain for an optical fiber of the plurality of optical fibers 150 including the EFPI.

The at least one corresponding optical sensing element 170 may include more than one FBG arranged in an optical fiber of the plurality of optical fibers 150. The at least one corresponding optical sensing element 170 may include one or more FBG's, such as 2 FGB's, or 3 FGB's, or 4 FGB's, or 5 FGB's, or 6 FGB's, or 7 FGB's, or 8 FGB's, or 9 FGB's, or 10 FGB's, or 12 FGB's, or 16 FGB's, or 20 FGB's, or 24 FGB's, or 28 FGB's, or 32 FGB's. The one or more FBG's may be arranged in series optically (e.g., along the length of the optical fiber). For example, a first FBG 173a may be configured with a first periodic spacing and a second FBG 173b may be configured with a second periodic spacing different from the first periodic spacing. The first FBG 173a may be arranged on along the optical fiber to be closer to the laser 120 than the second FBG 173b so that a portion of the light (e.g., from the laser 120) that is transmitted through the first FBG 173a is reflected by the second FBG 173b and a portion of the light that is reflected by the first FBG 173a is not reflected by the second FBG 173b. In this way, both the first FBG 173a and the second FBG 173b may provide measurements of the strain, temperature, and/or temperature difference at their respective locations along the optical fiber. Such a sequential layout of FBG elements in an optical fiber may allow for multiple measurements points from the single optical fiber.

There may be a practical limit as to the number of FBG's that may be arranged in a single optical fiber in this way based on the size of the wavelength band. Because each FBG may have a unique reflective wavelength, and elongation/contraction of the FBG may result in changes in the reflective wavelength, the spacing and number of FBG's arranged in a single optical fiber may need to take into account these potential changes to avoid an aliasing effect (e.g., when reflected wavelengths of two FBG's intersect one another).

The laser 120 may be configured to output a coordination signal to the optical sensor 190. Such a coordination signal may be configured to synchronize the operations of the laser 120 and the optical sensor 190. For example, a coordination signal from the laser 120 to the optical sensor 190 may be configured so that it is sent by the laser 120 when the laser 120 changes the discrete wavelength of the output light at each discrete wavelength of a sequence of discrete wavelengths. Such a coordination signal may include a start command configured to command the optical sensor 190 to start sensing optical fibers (e.g., each optical fiber, or one or more optical fibers) of the plurality of optical fibers 150. The coordination signal may include a clock configured to determine a sensing speed of the optical sensor 190.

Alternatively, the optical sensor 190 may be configured to output a coordination signal to the laser 120. The optical sensor 190 may be configured to send the coordination signal to the laser 120 commanding the laser 120 to change the wavelength of light output from the laser 120 to a different wavelength. The coordination signal may include a clock configured to determine a sweep speed of the laser 120.

The optical sensor system 100 may include may include a communications interface configured to transmit data collected by the optical sensor system 100 to an external device. For example, the optical sensor system 100 may include a wireless fidelity (WiFi), ethernet, or like interfaces which may be configurable to transmit data to an external device (e.g., a computer or similar device configured to receive the transmitted data).

The optical sensor system 100 may include a housing 110 (e.g., shown in dashed lines in FIG. 1) in which the laser 120, the optical network 140, the optical sensor 190 and the processor 180 are housed and through which the plurality of optical fibers 150 extend. The housing may be made of a material configured to withstand vibration and shock loads associated with aerospace components. For example, the housing may be made from aluminum, titanium, or alloys thereof, high strength-to-weight plastics such as acrylonitrile butadiene styrene (ABS), polyethylene terephthalate (PET), polyethylene (PE), high-density polyethylene (HDPE), nylon, polyphenylene sulfide (PPS), polyetherimide (PEI), polyamideimide (PAI), polyetheretherketone (PEEK), a combination of at least one of the foregoing, or the like.

The optical sensor system 100 may be integrated into an aerospace vehicle 200. An aerospace vehicle 200 may include a structural component (e.g., first structural component 111, second structural component 112, and third structural component 113 in FIG. 1) and the optical sensor system 100 may be configured so that at least one optical fiber of the plurality of optical fibers 150 is configured to sense a strain or a temperature of the structural component when the aerospace vehicle 200 is in service.

For example, a first optical fiber of the plurality of optical fibers 150 may be configured with a first EFPI 171 which may be attached (e.g., with an adhesive material such as epoxy) to the first structural component 111 of the aerospace vehicle 200 and configured to measure a strain associated with the first structural component 111. In another example, a second and a third optical fiber of the plurality of optical fibers 150 may be respectively configured with a second EFPI 172b and a first FBG 172a, which may be attached to the second structural component 112 of the aerospace vehicle 200 and configured to measure a strain associated with the second structural component 112 and a temperature of the second structural component 112. It is noted that when a EFPI is used in an optical fiber another optical fiber having a FBG configured to sense temperature may be co-located with the EFPI so as to be usable to provide temperature compensation for measurements taken by the EFPI.

A FBG used to sense temperature may be attached to a component (e.g., a structural component or a component in close proximity to the location where the temperature is to be measured) in a manner in which movement of the FBG is not constrained. For example, by attaching a tube to the component and inserting the optical fiber containing the FBG into the tube so as to allow for the optical fiber to move within the tube. In this way, mechanical strain of the optical fiber may be reduced or eliminated thereby allowing any elongation or contraction of the FBG to be attributable to a change in temperature of the FBG.

In another example, a fourth optical fiber of the plurality of optical fibers 150 may be configured with a series of FBG's including a second FBG 173a, a third FBG 173b, and a fourth FBG 173c, which may be attached to the third structural component 113 of the aerospace vehicle 200 and configured to measure a strain and/or a temperature associated with the third structural component 113 (e.g., at up to the three locations of the serially arranged three FBG's). The aerospace vehicle 200 may be configured with an external device configured to receive data transmitted from the optical sensor system 100 (e.g., through a wired or wireless connection between the external device and the optical sensor system 100).

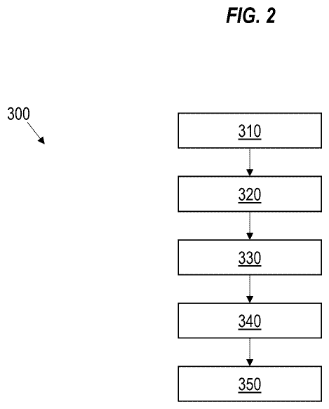

Turning now to FIG. 2, a method 300 of controlling an optical sensor system as described in the foregoing may include a first aspect 310 including changing a wavelength of light output by the laser 120 through a sequence of discrete wavelengths. For example, the changing the wavelength of light output of the laser 120 may include sequencing, or sweeping, the output of the laser 120 through a wavelength band (e.g., from a starting wavelength to an ending wavelength in steps of a discrete wavelength increment, such as 4 pm). As described in the foregoing, in an implementation, the wavelength band may include a band of 40 nm and the tuning resolution (e.g., the step size) of the laser 120 may be set to 4 pm so that changing from the smallest wavelength of the wavelength band to the largest wavelength of the wavelength band may include stepping, or sweeping, through the ten thousand 4 pm increments therebetween. In another implementation, the wavelength band may include a band of 40 nm and the tuning resolution of the laser 120 may be set to 40 pm so that changing from the smallest wavelength of the wavelength band to the largest wavelength of the wavelength band may include stepping, or sweeping through the one thousand 4 pm increments therebetween.

At each step the laser 120 may be configured to hold the new discrete wavelength fixed (e.g., for the dwell time of the laser 120) while the optical sensor 190 senses light reflected from the at least one corresponding optical sensing element 170 in optical fibers (e.g., one or more optical fibers, or each optical fiber) of the plurality of optical fibers 150. The processor 180 may obtain, from the optical sensor 190, data corresponding to the wavelength of the reflected light in correspondence with the new discrete wavelength at steps (e.g., each step) as the laser changes through the wavelength band. Accordingly, the method 300 may include a second aspect 320 including obtaining, from the optical sensor 190, data corresponding to the wavelength of the reflected light through optical fibers (e.g., one or more optical fibers, or each optical fiber) of the plurality of optical fibers 150 in correspondence with discrete wavelengths (e.g., one or more wavelengths, or each wavelength) of the sequence of discrete wavelengths. The second aspect 320 may include switching (e.g., with an electronically controlled analog switch) an analog-to-digital converter of the optical sensor 190 between two or more optical fibers (e.g., or photodiodes associated therewith) of the plurality of optical fibers 150 so that the optical sensor 190 may interpret the light reflected through optical fibers (e.g., one or more optical fibers, or each optical fiber) of the plurality of optical fibers 150 without the need for separate dedicated analog-to-digital converters for each optical fiber (e.g., or photodiodes associated therewith) of the plurality of optical fibers 150. The second aspect 320 may include converting with the analog-to-digital converter an analog electrical signal from a photodiode, based on a number of photons received by a photodiode, to a digital signal. The second aspect 320 of the method 300 may include time division multiplexing discrete outputs corresponding to the light reflected through the plurality of optical fibers 150 with a data acquisition system including at least one of the optical sensor 190 and the processor 180.

The at least one corresponding optical sensing element 170 may include an EFPI or at least one FBG, and light reflected from the at least one corresponding optical sensing element 170 may be interrogated by the optical sensor 190. Therefore, the method 300 may include a third aspect 330 including determining a strain for an optical fiber of the plurality of optical fibers 150. For example, a strain associated with the at least one corresponding optical sensing element 170 may be based on at least one of a wavelength difference between the output light of the discrete wavelength and the wavelength of the reflected light (e.g., for FGB elements), and a phase change of the reflected light from the two ends of the EFPI (e.g., for EFPI elements). Accordingly, the third aspect 330 may include determining a strain for an optical fiber of the plurality of optical fibers 150 which include the EFPI or the at least one FBG.

In an implementation, the at least one corresponding optical sensing element 170 may include an EFPI. In this case, the third aspect 330 of the method 300 may include determining a strain for an optical fiber of the plurality of optical fibers that includes the EFPI which may be based on a phase change of the reflected light from the two ends of the EFPI.

In an implementation, the at least one corresponding optical sensing element 170 may include an FBG. In this case, the third aspect 330 of the method 300 may include determining a strain for an optical fiber of the plurality of optical fibers that includes the at least one FBG based on a wavelength difference between the output light of the discrete wavelength and the wavelength of the reflected light. For example, the third aspect 330 of the method 300 may include calculating a strain based on Equation 2.

Further, a fourth aspect 340 of the method 300 may include determining a temperature of an optical fiber of the plurality of optical fibers 150 including the at least one FBG based on a wavelength difference between the output light of the discrete wavelength and the wavelength of the reflected light. For example, the fourth aspect 340 of the method 300 may include calculating a change in temperature based on Equation 2 then calculating a temperature based a known temperature (e.g., a temperature of the FGB when the FGB was manufactured, a temperature known to correspond to a certain periodic spacing of the FBG, or the like) and the calculated change in temperature.

The method 300 may further include a fifth aspect 350 of outputting (e.g., transmitting), with the laser 120, a coordination signal to the optical sensor 190. For example, the laser 120 may output to the optical sensor 190 the coordination signal when the laser 120 changes (e.g., steps) the discrete wavelength of the output light. The laser 120 may transmit the coordination signal at discrete wavelengths (e.g., one or more wavelengths, or each wavelength) of the sequence of discrete wavelengths through which the laser 120 sweeps as it sequences from through a wavelength band.

As used herein, each of the phrases such as “A or B,” “at least one of A and B,” “at least one of A or B,” “A, B or C,”, A, B, and C”, “at least one of A, B, and C,” and “at least one of A, B, or C” may include any one of the listed items, or all possible combinations thereof. For example, use of “at least one of” preceding a group of items should be interpreted in a disjunctive way with respect to the group of items, e.g., so that presence of one item of the group meets the meaning of the recitation.

As used herein, the words “a,” “an” and “the” are intended to include plural forms of elements unless specifically referenced as a single element.

As used herein, the term “and/or” includes a combination of a plurality of related listed components, or any component among the plurality of related listed components.

As used herein, terms such as “first,” “second,” or “first” or “second” may be used simply to distinguish one component from other components, and do not limit the components in other aspects (e.g., importance or order).

As used herein, the terms “comprise(ing)”, “include(ing)” or “have(ing)” are intended to indicate the presence of a characteristic, number, step, operation, process, component, part, feature, function, and/or element, or any combination thereof described in the present document, and the possibility of the presence or addition of one or more other characteristics, numbers, steps, operations, processes, components, parts, features, functions, and/or elements, or any combination thereof is not precluded.

As used herein, when a component is “connected,” “coupled,” “supported,” or “in contact” with another component, this includes not only cases in which components are directly connected, coupled, supported, or in contact with each other, but also cases in which they are indirectly connected, coupled, supported, or in contact through a third component.

As used herein, when a component is disposed “on” another component, this includes not only a case in which the component is in contact with another component, but also a case in which still another member is present between the two components.

As used herein, a term, such as “about” or “substantially,” is used at a corresponding numerical value or used as a meaning close to the numerical value when e.g., manufacturing and material tolerances which may be inherent in the stated meaning are presented. In particular, as used herein, the terms “about” and “approximately” refer to values that are plus or minus ten percent of the base value. That is, for example, reference to “about 100” or “approximately 100” refers to “90-110” inclusive. In some implementations, “about” may refer to plus or minus five percent of the base value, or plus or minus two percent of the base value.

What is claimed is:

1. An optical sensor system comprising:
a plurality of optical fibers, each optical fiber of the plurality of optical fibers having at least one corresponding optical sensing element configured to reflect light;
a laser configured to output light of a discrete wavelength and to change the discrete wavelength of the output light through a sequence of discrete wavelengths;
an optical network connecting the laser to the plurality of optical fibers, and configured to split the output light of the discrete wavelength so that a split portion of the output light of the discrete wavelength is transmitted through an optical fiber of the plurality of optical fibers to the at least one corresponding optical sensing element and at least a portion of the split portion is reflected by the at least one corresponding optical sensing element;
an optical sensor configured to obtain information about the reflected light through optical fibers of the plurality of optical fibers and to output data corresponding to the information about the reflected light; and
a processor configured to:
obtain, from the optical sensor, the data corresponding to the information about the reflected light in correspondence with discrete wavelengths of the sequence of discrete wavelengths.

2. The optical sensor system of claim 1, wherein
the at least one corresponding optical sensing element includes an extrinsic Fabry-Perot interferometer and the information about the reflected light includes an amplitude of the reflected light, or the at least one corresponding optical sensing element includes at least one fiber Braggs grating and the information about the reflected light includes a wavelength of the reflected light, and
the processor is further configured to:
based on at least one of a wavelength difference between the output light of the discrete wavelength and the wavelength of the reflected light and a phase change between an amplitude of the output light of the discrete wavelength and the amplitude of the reflected light,
determine a strain for an optical fiber of the plurality of optical fibers including the extrinsic Fabry-Perot interferometer or the at least one fiber Braggs grating, or
determine a temperature of an optical fiber of the plurality of optical fibers including the at least one fiber Braggs grating.

3. The optical sensor system of claim 1, wherein
the at least one corresponding optical sensing element includes an extrinsic Fabry-Perot interferometer,
the information about the reflected light includes an amplitude of the reflected light, and
the processor is further configured to:
based on a phase change between an amplitude of the output light of the discrete wavelength and the amplitude of the reflected light,
determine a strain for an optical fiber of the plurality of optical fibers that includes the extrinsic Fabry-Perot interferometer.

4. The optical sensor system of claim 1, wherein
the at least one corresponding optical sensing element includes at least one fiber Braggs grating,
the information about the reflected light includes a wavelength of the reflected light, and
the processor is further configured to:
based on a wavelength difference between the output light of the discrete wavelength and the wavelength of the reflected light,
determine a strain for an optical fiber of the plurality of optical fibers that includes the at least one fiber Braggs grating.

5. The optical sensor system of claim 1, wherein
the at least one corresponding optical sensing element includes at least one fiber Braggs grating,
the information about the reflected light includes a wavelength of the reflected light, and
the processor is further configured to:
based on a wavelength difference between the output light of the discrete wavelength and the wavelength of the reflected light,
determine a temperature of an optical fiber of the plurality of optical fibers that includes the at least one fiber Braggs grating.

6. The optical sensor system of claim 1, wherein the sequence of discrete wavelengths includes wavelengths between about 1400 nanometers to about 1600 nanometers.

7. The optical sensor system of claim 1, wherein the processor is further configured to change, with the laser, the discrete wavelength of the output light through the sequence of discrete wavelengths within about 50 milliseconds.

8. The optical sensor system of claim 1, wherein
the optical sensor further includes an optical to electrical amplifier configured to convert the wavelength of light reflected by the at least one corresponding optical sensing element into an electrical signal.

9. The optical sensor system of claim 1, wherein
the laser is configured to output a coordination signal to the optical sensor when the laser changes the discrete wavelength of the output light at each discrete wavelength of the sequence of discrete wavelengths, and the coordination signal includes:
a start command to start sensing with the optical sensor, and
a clock to determine a sensing speed of the optical sensor.

10. The optical sensor system of claim 1, wherein the processor is further configured to: obtain, from the optical sensor, the data corresponding to the information about the reflected light through each optical fibers of the plurality of optical fibers in correspondence with each discrete wavelength of the sequence of discrete wavelengths.

11. The optical sensor system of claim 1, further comprising a housing in which the laser, the optical network, the optical sensor and the processor are housed and through which the plurality of optical fibers extend.

12. An aerospace vehicle comprising:
a structural component; and
the optical sensor system of claim 1, wherein at least one optical fiber of the plurality of optical fibers is configured to sense a strain or a temperature of the structural component when the aerospace vehicle is in service.

13. The aerospace vehicle of claim 12, wherein the optical sensor system is configured to transmit data collected by the processor to an external device.

14. A method of controlling an optical sensor system including a plurality of optical fibers, each optical fiber of the plurality of optical fibers having at least one corresponding optical sensing element configured to reflect light, a laser configured to output light of a discrete wavelength and to change the discrete wavelength of the output light through a sequence of discrete wavelengths, an optical network connecting the laser to the plurality of optical fibers, and configured to split the output light of the discrete wavelength so that a split portion of the output light of the discrete wavelength is transmitted through each optical fiber of the plurality of optical fibers to the at least one corresponding optical sensing element and at least a portion of the split portion is reflected by the at least one corresponding optical sensing element, an optical sensor configured to obtain information about the reflected light through each optical fiber of the plurality of optical fibers and to output data corresponding to the information about the reflected light, and a processor, the method comprising:
changing a wavelength of light output by the laser through the sequence of discrete wavelengths; and
obtaining, from the optical sensor, the data corresponding to the information about the reflected light in correspondence with discrete wavelengths of the sequence of discrete wavelengths.

15. The method of claim 14, wherein the at least one corresponding optical sensing element includes an extrinsic Fabry-Perot interferometer and the information about the reflected light includes an amplitude of the reflected light, or the at least one corresponding optical sensing element includes at least one fiber Braggs grating and the information about the reflected light includes a wavelength of the reflected light, and the method further comprises:
based on at least one of a wavelength difference between the output light of the discrete wavelength and the wavelength of the reflected light and a phase change between an amplitude of the output light of the discrete wavelength and the amplitude of the reflected light,
determining a strain for an optical fiber of the plurality of optical fibers including the extrinsic Fabry-Perot interferometer or the at least one fiber Braggs grating, or
determining a temperature of an optical fiber of the plurality of optical fibers including the at least one fiber Braggs grating.

16. The method of claim 14, wherein the at least one corresponding optical sensing element includes an extrinsic Fabry-Perot interferometer, the information about the reflected light includes an amplitude of the reflected light, and the method further comprises:
based on a phase change between an amplitude of the output light of the discrete wavelength and the amplitude of the reflected light,
determining a strain for an optical fiber of the plurality of optical fibers that includes the extrinsic Fabry-Perot interferometer.

17. The method of claim 14, wherein the at least one corresponding optical sensing element includes at least one fiber Braggs grating, the information about the reflected light includes a wavelength of the reflected light, and the method further comprises:
based on a wavelength difference between the output light of the discrete wavelength and the wavelength of the reflected light,
determining a strain for an optical fiber of the plurality of optical fibers that includes the at least one fiber Braggs grating.

18. The method of claim 14, wherein the at least one corresponding optical sensing element includes at least one fiber Braggs grating, the information about the reflected light includes a wavelength of the reflected light, and the method further comprises:
based on a wavelength difference between the output light of the discrete wavelength and the wavelength of the reflected light,
determining a temperature of an optical fiber of the plurality of optical fibers that includes the at least one fiber Braggs grating.

19. The method of claim 14, wherein the sensing includes sensing the information about the reflected light through each optical fiber of the plurality of optical fibers in correspondence with each discrete wavelengths of the sequence of discrete wavelengths.

20. The method of claim 14, further comprising:
outputting, with the laser, a coordination signal to the optical sensor when the laser changes the discrete wavelength of the output light at discrete wavelengths of the sequence of discrete wavelengths.
